(19) United States
(12) Patent Application Publication
(10) Pub. No.: US 2010/0043656 A1
(43) Pub. Date: Feb. 25, 2010

(54) MASK CLEANING APPARATUS AND MASK CLEANING METHOD

(75) Inventor: MASATOSHI SUGIURA, Kanagawa (JP)

Correspondence Address: YOUNG & THOMPSON, 209 Madison Street, Suite 500, Alexandria, VA, 22314, US

(73) Assignee: NEC Electronics Corporation, Kanagawa (JP)

(21) Appl. No.: 12/538,442

(22) Filed: Aug. 10, 2009

(30) Foreign Application Priority Data
Aug. 21, 2008 (JP) 2008-213124

(51) Int. Cl. B41M 1/12; B41F 35/00

(52) U.S. Cl. 101/129; 101/425

(57) ABSTRACT

A screen mask cleaning apparatus including an upper wiping sheet for cleaning the upper surface of a screen mask in which the upper wiping sheet is brought into contact only by its own weight with the upper surface of the screen mask, and a screen mask cleaning method performed by using the screen mask cleaning apparatus.

### FIELD OF THE INVENTION

The present invention relates to a mask cleaning apparatus and a mask cleaning method for a screen mask used in screen printing.

### BACKGROUND OF THE INVENTION

A screen printing method is one of methods used upon forming bumps on a wafer electrode pad in a process for manufacturing semiconductor devices. FIG. 4 shows a flow for forming bumps by the screen printing method. A bump forming method by screen printing is to be described specifically.

FIGS. 4A to 4F are cross sectional views showing the outline of a bump forming step by using a screen mask. FIG. 4A is a cross sectional view of a wafer 3 having an electrode pad 4. As shown in FIG. 4B, a screen mask aperture 2 is positionally aligned with an electrode pad 4 of the water 3, and the wafer 3 and a screen mask 1 are in contact to each other. Then, as shown in FIG. 4C, a solder paste 5 (mixture of a solder powder and a flux) as a printing agent is supplied over the screen mask 1, and squeezed by a squeegee 7, the printing agent is filled in the screen mask aperture 2 by squeezing. After filling the printing agent to all screen mask apertures 2, the screen mask 1 is detached from the wafer 3. In this case, while a portion of the printing agent is deposited to the screen mask 1 on the side wall of the aperture and the surface and the rear face thereof, as shown in FIG. 4E, most of the printing agent remains on the electrode pad 4 as shown in FIG. 4D. By a reflow treatment to the wafer 3 to which the printing agent has been supplied on the electrode pad 4, the solder in the printing agent is melted and solidified and the flux component remains on the surface of the bump 6 (volatile component of the flux is evaporated). Then, by applying a cleaning treatment to the flux remaining on the surface of the bump 6, formation of the bump 6 is completed as shown in FIG. 4F. For removing the deposited printing agent, cleaning is applied on every use to the screen mask 1 deposited with the printing agent shown in FIG. 4E.

FIGS. 5A to 5D show an existent arrangement of a screen mask 1 during cleaning. FIG. 5A is a cross sectional view of the screen mask 1 in which the printing agent (solder past 5) is partially left and deposited. FIG. 5B shows schematic side elevation and schematic front elevation of a mask cleaning apparatus. In the cleaning for the screen mask 1, as shown in FIG. 5C, at first, the screen mask 1 is sandwiched from above and below by way of upper and lower wiping sheets 11, 21 between upper and lower wiping sheet pressing members 10, 20. In this case, the screen mask 1 undergoes a pressure from each of the upper and lower wiping sheet pressing members 10, 20 to the screen mask 1 in a direction perpendicular to the surface of the screen mask (in the direction of an arrow Z in FIG. 5B). In this state, each of the upper and lower wiping sheet pressing members 10, 20 is reciprocated in the direction shown by an arrow X in FIGS. 5B, 5C. Since a cleaning agent is coated to the wiping sheets 11, 21 before the cleaning operation, the printing agent deposited to the screen mask 1 is cleaned by the wiping sheets 11, 21 reciprocal movement of the wiping sheet pressing members 10, 20 (FIG. 5D).

JP-A No. 2004-82463 and JP-A No. 09-39214 disclose an example of a cleaning device having such wiping sheets for screen mask.

In the existent cleaning device of the screen mask, the wiping sheet pressing member is disposed at a position in contact with the upper surface of the screen mask in a state where the wiping sheet is not present. By sandwiching the wiping sheet between the screen mask and the pressing member in this state, the wiping sheet is in close contact with the screen mask and pressed to improve the cleaning effect.

### SUMMARY OF THE INVENTION

In the cleaning device described above, obstacles tend to be deposited on the screen mask upon cleaning of the screen mask to result in the following problem, when the obstacles are put between the screen mask and the wiping sheet.

FIG. 6 is a schematic cross sectional view showing a state where an obstacle 8 is put between the screen mask 1 and the upper wiping sheet 11. Since the screen mask 1 is pressed by the wiping sheet pressing member 10, when the obstacle 8 is present between them, a pressure exerting on the screen mask 1 is localized to a place where the obstacle 8 is present. Deformation such as indent is generated at the portion of the screen mask 1 that undergoes the localized load.

FIGS. 7A to 7C are schematic cross sectional views showing the state of performing printing by the screen mask 1 that undergoes the deformation as described above. When the deformed screen mask 1 is in contact with the wafer 3, a clearance is formed between the screen mask 1 and the wafer 3. When the printing agent is filled by squeezing in this state, the printing agent intrudes into the clearance as shown in FIG. 7A. When the screen mask is detached from the wafer 3 in this state, the printing agent supplied to the clearance remains on the wafer electrode as shown in FIG. 7B. The amount of the printing agent supplied on the wafer electrode in this case is more than the amount supplied by the screen mask 1 with no deformation. Excessive supply of the printing agent joins adjacent bumps 6 to each other by the reflow step (FIG. 7C), to result in a problem, for example, of generating failure such as electric short-circuit to a semiconductor device.

As described above, in the related art, cleaning effect is enhanced by sandwiching the wiping sheet between the screen mask and the pressing member under pressure. Heretofore, this has been accepted as a customary constitutional specification for the cleaning of the screen mask. However, the present inventors have found that an overall yield can be improved though the cleaning efficiency is somewhat lowered by a constitution of not using the upper screen, particularly, for the upper surface of the screen mask to which obstacles tend to be deposited because the screen mask is no more deformed by the obstacles.

In accordance with the first aspect, a mask cleaning apparatus of the invention for cleaning a screen mask used for screen printing by a wiping sheet has an upper wiping sheet for cleaning the upper surface of the screen mask in which the upper wiping sheet is in contact with the upper surface of the screen mask without exerting a pressing force to the upper surface of the screen mask. Since the pressing force does not exert on the upper surface of the screen mask, the upper wiping sheet is in contact with the upper surface of the screen mask basically only by its own weight. The own weight means herein an own weight usually also including the weight of a detergent (cleaning agent) and the wiping sheet can be in brought into close contact with the upper surface of the screen mask together with an adsorption effect due to the surface tension of the cleaning agent.

In accordance with the second aspect, a mask cleaning method of the invention for cleaning the screen mask used for screen printing by a wiping sheet brings an upper wiping sheet for cleaning the upper surface of the screen mask into contact with the upper surface of the screen mask without exerting a pressing force to the upper surface of the screen mask. Since the pressing force does not exert to the upper surface of the screen mask, the upper wiping sheet is in contact with the upper surface of the screen mask basically by its own weight. The own weight means an own weight usually including also the cleaning agent, and the wiping sheet can be brought into close contact with the upper surface of the screen mask together with the adsorption effect due to the surface tension of the cleaning agent.

Since the upper pressing member is not provided, even when obstacles are present on the screen mask, the screen mask undergoes no localized pressing force. Accordingly, the screen mask is not deformed even when the obstacle is put between the screen mask and the wiping sheet, and the failure of a semiconductor device such as electric short-circuit is not generated by the deformation of the screen mask.

### BRIEF DESCRIPTION OF THE DRAWINGS

FIG. 1 shows a positional relation between a screen mask and an upper wiping sheet in a mask cleaning apparatus according to a preferred embodiment of the invention;

FIG. 2 is a side elevational view of a cleaning mechanism according to an embodiment of the invention in a case where an obstacle is present in the mask cleaning apparatus;

FIG. 3 is a graph showing the yield in the inspection of bumps manufactured by the related art and the embodiment of the invention;

FIGS. 4A to 4F show the outline of a bump forming step using a screen mask, in which

FIG. 4A is a cross sectional view of a wafer having an electrode pad;

FIG. 4B is a cross sectional view of a wafer carrying a screen mask thereon;

FIG. 4C is a cross sectional view in a case of squeezing a solder paste by a squeegee;

FIG. 4D is a cross sectional view showing a printing agent remaining on an electrode pad;

FIG. 4E shows a screen mask in which the printing agent is partially left and deposited; and

FIG. 4F shows a cross sectional view of the wafer formed with bumps;

FIGS. 5A to 5D show an arrangement of an existent screen mask during cleaning, in which

FIG. 5A shows a screen mask in which a printing agent is partially left and deposited;

FIG. 5B shows schematic side elevation and schematic front elevation of a mask cleaning apparatus;

FIG. 5C is a cross sectional view in which a screen mask is sandwiched between wiping sheet pressing members by way of wiping sheets,

FIG. 5D shows a screen mask from which the printing agent is cleaned off;

FIG. 6 is a cross sectional view of an existent cleaning device in which an obstacle is present;

FIG. 7A to 7C show the state of printing by using a screen mask undergoing deformation in the related art, in which

FIG. 7A is a cross sectional view in which the printing agent intrudes to a portion below a deformed screen mask,

FIG. 7B shows a printing agent remaining on the wafer, and

FIG. 7C is a cross sectional view for bumps suffering from short circuit.

### DESCRIPTION OF THE PREFERRED EMBODIMENTS

The mask cleaning apparatus according to the invention preferably has a supply/take-up member for upper wiping sheet for moving the upper wiping sheet while bring the same into contact with the upper surface of the screen mask.

The supply/take-up member for the upper wiping sheet may be arranged to a position not only at a height identical with or above the screen mask but also to a position at a height below the screen mask. In any case, the upper wiping sheet can be brought into close contact with the upper surface of the screen mask.

Further, the mask cleaning apparatus according to the invention may have a lower wiping sheet for cleaning the lower surface of the screen mask and a lower pressing member for bringing the lower wiping sheet into contact with the lower surface of the screen mask. A supply/take-up member for the lower wiping sheet may also be provided.

Further, the upper surface of the screen mask can be cleaned in a state where the upper cleaning sheet is brought into contact with the upper surface of the screen mask by moving either one or both of them relatively.

Further, according to the mask cleaning method of the invention, the upper surface of the screen mask can be cleaned by moving the upper wiping sheet while bringing the same into contact with the upper surface of the screen mask by the supply/take-up member for the wiping sheet.

Further, the lower surface of the screen mask can be cleaned by bringing the lower wiping sheet for cleaning the lower surface of the screen mask into contact with the lower surface of the screen mask by using a lower pressing member for bringing the lower wiping sheet into contact with the lower surface of the screen mask.

Further, the upper surface of the screen mask can be cleaned in a state of bringing the upper wiping sheet and the upper surface of the screen mask into contact with each other by moving either one or both of them relatively.

Preferred embodiments of the present invention are to be described specifically with reference to the drawings.

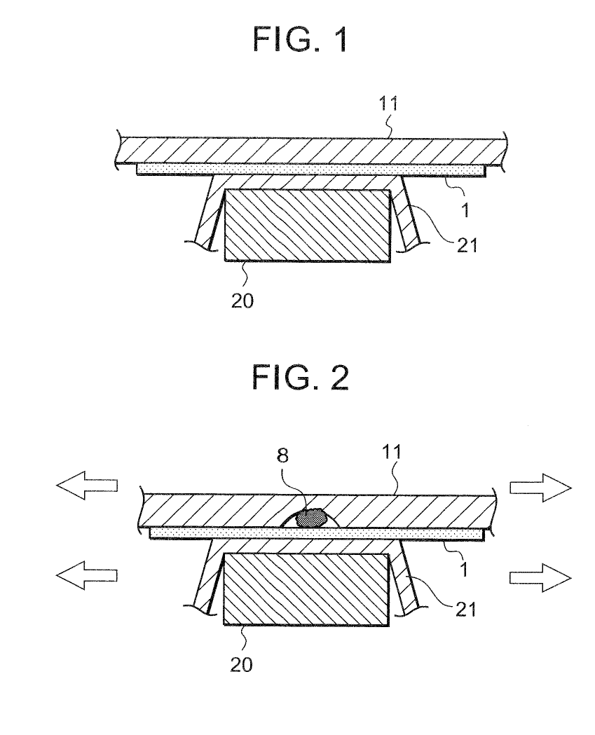

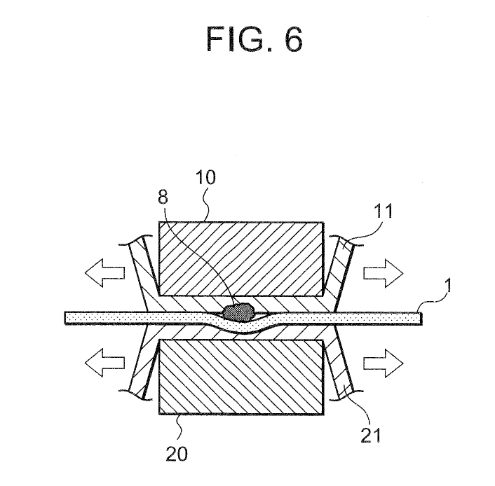

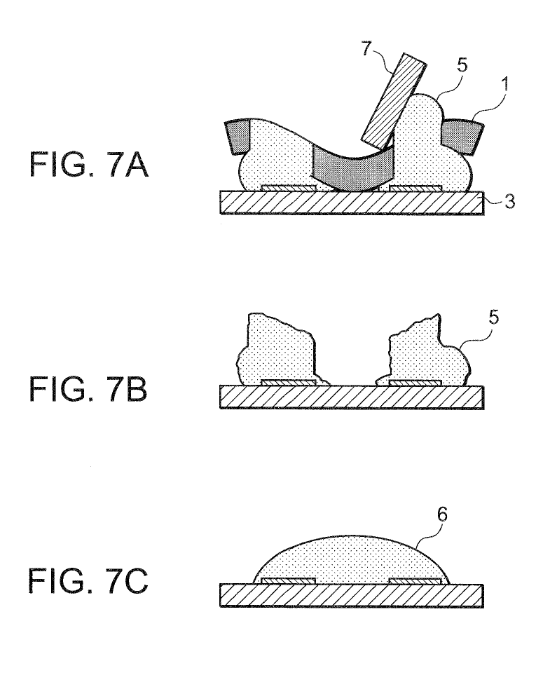

FIG. 1 is a schematic cross sectional view showing a positional relation for a screen mask 1 and an upper wiping sheet 11 (further, lower wiping sheet pressing member 20, lower wiping sheet 21) in a mask cleaning apparatus of a preferred embodiment of the invention. In the related art, as shown in FIG. 6, for improving the cleaning efficiency of the screen mask 1, the wiping sheet 11 is pressed by the upper wiping sheet pressing member 10 to exert a strong pressing force on the screen mask 1. On the other hand, in the first embodiment of the invention, as shown in FIG. 1, the upper wiping sheet pressing member 10 is not used.

As a result, the cleaning efficiency of a screen mask 1 is somewhat lowered, but this gives not so much effect on the formation of the bump. Even when an obstacle 8 is put between an upper wiping sheet 11 and the screen mask 1 upon cleaning the screen mask 1 as shown in FIG. 2, the upper wiping sheet 11 deforms conforming to the size of the obstacle 8 and does not exert pressure in the screen mask 1. Accordingly, it has been found that deformation of the screen mask 1 can be suppressed and, as a result, short-circuit of the bump is no more generated. Further, the arrangement for the relation between the lower wiping sheet pressing member 20 and the lower wiping sheet 21 is made identical with that of the existent case.

The upper wiping sheet 11 containing a cleaning agent is supplied and taken up by an upper wiping sheet supply portion and an upper wiping sheet take-up portion not illustrated in FIG. 1 and FIG. 2 (hereinafter both of them are referred to collectively as “supply/take-up member for upper wiping sheet”), in which the upper surface of the screen mask is cleaned. While the upper wiping sheet 11 is not pressed by the upper wiping sheet pressing member or the like, it has been found that the upper wiping sheet 11 is brought into close contact with the upper surface of the screen mask by its own weight including also the weight of the cleaning agent and the surface tension and a practically sufficient cleaning effect can be obtained. As the cleaning agent, ethanol can be used for instance but this is not limitative.

For the structure of the supply/take-up member for upper wiping sheet, any existent structure is applicable. However, since the upper wiping sheet pressing member is not used, it is adapted, for example, such that the upper wiping sheet is arranged so as to move along the upper surface of the screen mask by a roller or the like, or the supply/take-up member for upper wiping sheet is arranged at a height identical with that of the screen mask. It is also possible to arrange the supply/take-up portion for upper wiping sheet at a height lower than that of the screen mask. Since the constitution for such arrangement is obvious to a person skilled in the art, detailed descriptions therefor are to be omitted.

Further, instead of moving the wiping sheet, it maybe considered to adopt an arrangement of passing a screen mask between upper and lower wiping sheets for cleaning. It is important that the screen mask can be cleaned by moving the wiping sheet and the screen mask relatively in a state where they are in contact to each other under no particular pressurization.

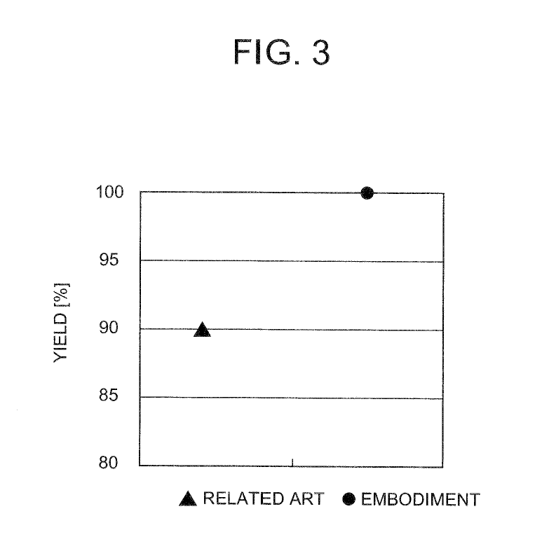

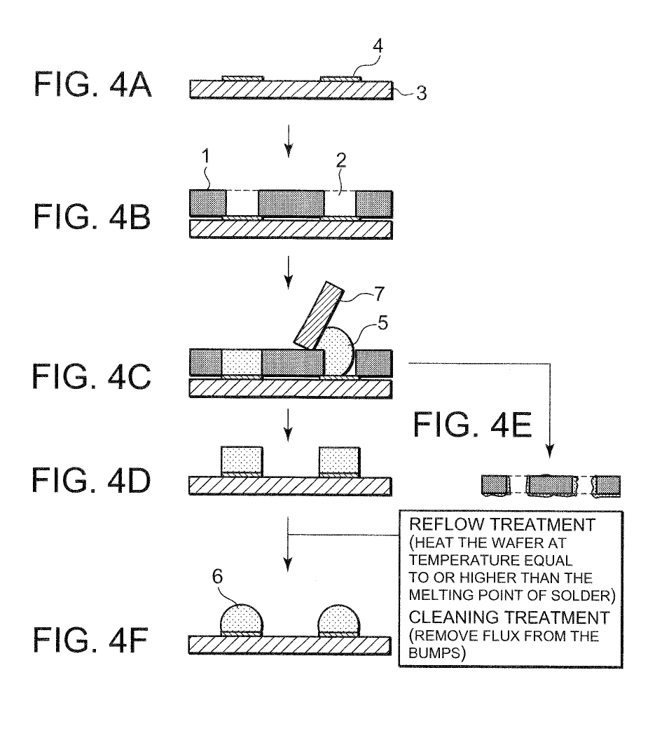

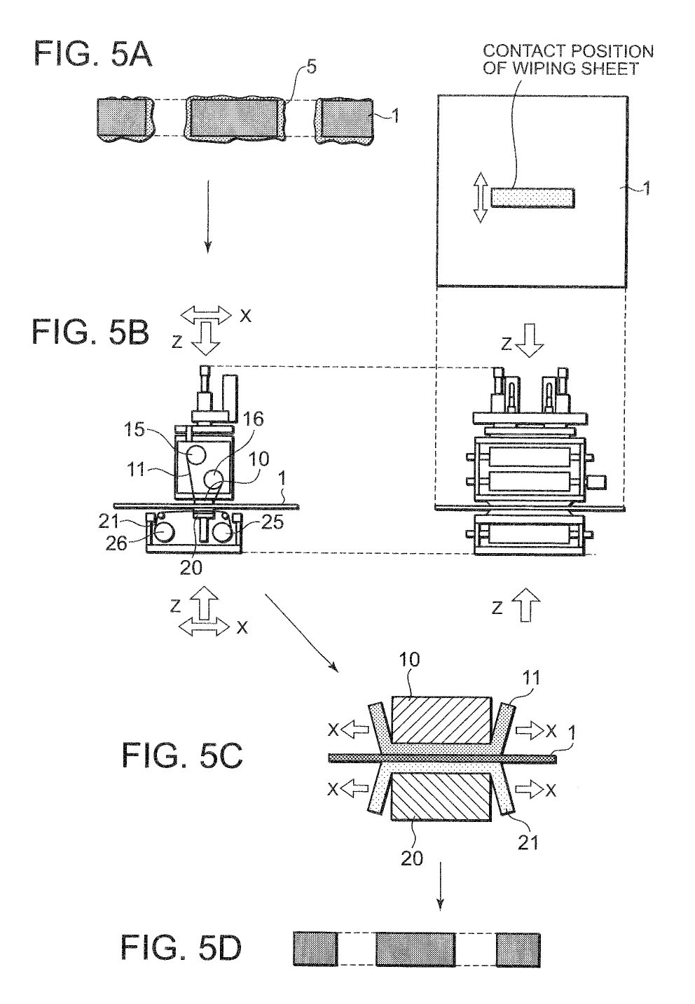

FIG. 3 is a graph showing the yield in the bump inspection in comparison between the related art and the embodiment of the invention. While the yield was about 90% in the related art, it is greatly improved in this embodiment to about 100%. That is, by using the mask cleaning apparatus and the mask cleaning method according to the invention, screen printing can be carried out in a high yield and failure of semiconductor devices caused by local deformation of the screen mask during cleaning can be decreased drastically.

While the present invention has been described with reference to the preferred embodiments, the invention is not restricted only to the constitution of the embodiments described above but it will be apparent that the invention includes various modifications or improvements that may be done by a person skilled in the art within the scope of the invention.

What is claimed is:

1. A mask cleaning apparatus for cleaning a screen mask used for screen printing, comprising:
an upper wiping sheet for cleaning the upper surface of the screen mask,
wherein the upper wiping sheet is brought into contact with the upper surface of the screen mask without exerting a pressing force to the upper surface of the screen mask.

2. The mask cleaning apparatus according to claim 1, further comprising:
a supply/take-up member for upper wiping sheet moving the upper wiping sheet while bringing the upper wiping sheet into contact with the upper surface of the screen mask.

3. The mask cleaning apparatus according to claim 1, further comprising:
a lower wiping sheet for cleaning the lower surface of the screen mask; and
a lower pressing member for bringing the lower wiping sheet into contact with the lower surface of the screen mask.

4. The mask cleaning apparatus according to claim 1, wherein the upper surface of the screen mask is cleaned in a state of bringing the upper wiping sheet into contact with the upper surface of the screen mask, by relatively moving one of the upper wiping sheet and the upper surface of the screen mask.

5. The mask cleaning apparatus according to claim 1, wherein the upper surface of the screen mask is cleaned in a state of bringing the upper wiping sheet into contact with the upper surface of the screen mask, by relatively moving both of the upper wiping sheet and the upper surface of the screen mask.

6. A mask cleaning method for cleaning a screen mask used for screen printing by a wiping sheet, the method comprising:
bringing the upper wiping sheet for cleaning the upper surface of the screen mask into contact with the upper surface of the screen mask without exerting a pressing force to the upper surface of the screen mask.

7. The mask cleaning method according to claim 6, wherein the upper surface of the screen mask is cleaned by moving the upper wiping sheet while bringing the upper wiping sheet into contact with the upper surface of the screen mask by a supply/take-up member for upper wiping sheet.

8. The mask cleaning method according to claim 6, wherein the lower surface of the screen mask is cleaned by bringing the lower wiping sheet for cleaning the lower surface of the screen mask into contact with the lower surface of the screen mask by using a lower pressing member for bringing the lower wiping sheet into contact with the lower surface of the screen mask.

9. The mask cleaning method according to claim 7, wherein the lower surface of the screen mask is cleaned by bringing the lower wiping sheet for cleaning the lower surface of the screen mask into contact with the lower surface of the screen mask by using a lower pressing member for bringing the lower wiping sheet into contact with the lower surface of the screen mask.

10. The mask cleaning method according to claim 6, wherein the upper surface of the screen mask is cleaned in a state of bringing the upper wiping sheet into contact with the upper surface of the screen mask by relatively moving one of the upper wiping sheet and the upper surface of the screen mask.

11. The mask cleaning method according to claim 6, wherein the upper surface of the screen mask is cleaned in a state of bringing the upper wiping sheet into contact with the upper surface of the screen mask by relatively moving both of the upper wiping sheet and the upper surface of the screen mask.
